(19) United States
(12) Patent Application Publication
(10) Pub. No.: US 2016/0034027 A1
(43) Pub. Date: Feb. 4, 2016

(54) OPTICAL TRACKING OF A USER-GUIDED OBJECT FOR MOBILE PLATFORM USER INPUT

(71) Applicant: QUALCOMM Incorporated, San Diego, CA (US)

(72) Inventors: Tao SHENG, Richmond Hill (CA); Alwyn DOS REMEDIOS, Vaughan (CA)

(21) Appl. No.: 14/446,169

(22) Filed: Jul. 29, 2014

(51) Int. Cl. G06F 3/00; G06T 7/00; G06F 3/0488; G06F 3/041; G06F 3/03; G06F 3/01

(52) U.S. Cl. CPC G06F 3/005; G06F 3/0304; G06F 3/017; G06F 3/04883; G06F 3/04886; G06F 3/0416; G06T 7/004; G06T 2207/20081

(57) ABSTRACT

A method of receiving user input by a mobile platform includes capturing a sequence of images with a camera of the mobile platform. The sequence of images includes images of a user-guided object in proximity to a planar surface that is separate and external to the mobile platform. The mobile platform then tracks movement of the user-guided object about the planar surface by analyzing the sequence of images. Then the mobile platform recognizes the user input based on the tracked movement of the user-guided object.

### TECHNICAL FIELD

This disclosure relates generally to receiving user input by a mobile platform, and in particular but not exclusively, relates to optical recognition of user input by a mobile platform.

### BACKGROUND INFORMATION

Many mobile devices today include virtual keyboards, typically displayed on a touch screen of the device, for receiving user input. However, virtual keyboards on touch screen devices are far too small to be useful when compared to the ease of use of full size personal computer keyboards. Since the virtual keyboards are small, the user has to frequently switch the virtual keyboard between letter input, numeric input, and symbolic input, reducing the rate at which characters can be input by the user.

Recently, some mobile devices have been designed to include the ability to project a larger or even full size virtual keyboard onto a table top or other surface. However, this requires that an additional projection device be included in the mobile device increasing costs and complexity of the mobile device. Furthermore, projection keyboards typically lack haptic feedback making them error-prone and/or difficult to use.

### BRIEF SUMMARY

Accordingly, embodiments of the present disclosure include utilizing the camera of a mobile device to track a user-guided object (e.g., a finger) moved by the user across a planar surface so as to draw characters, gestures, and/or to provide mouse/touch screen input to the mobile device.

For example, according to one aspect of the present disclosure, a method of receiving user input by a mobile platform includes capturing a sequence of images with a camera of a mobile platform. The sequence of images includes images of a user-guided object in proximity to a planar surface that is separate and external to the mobile platform. The mobile platform then tracks movement of the user-guided object about the planar surface by analyzing the sequence of images. Then the mobile platform recognizes the user input based on the tracked movement of the user-guided object.

According to another aspect of the present disclosure, a non-transitory computer-readable medium includes program code stored thereon, which when executed by a processing unit of a mobile platform, directs the mobile platform to receive user input. The program code includes instructions to capture a sequence of images with a camera of the mobile platform. The sequence of images includes images of a user-guided object in proximity to a planar surface that is separate and external to the mobile platform. The program code further includes instructions to track movement of the user-guided object about the planar surface by analyzing the sequence of images and to recognize the user input to the mobile platform based on the tracked movement of the user-guided object.

In yet another aspect of the present disclosure, a mobile platform includes means for capturing a sequence of images which include a user-guided object that is in proximity to a planar surface that is separate and external to the mobile platform. The mobile device also includes means for tracking movement of the user-guided object about the planar surface and means for recognizing user input to the mobile platform based on the tracked movement of the user-guided object.

In a further aspect of the present disclosure, a mobile platform includes a camera, memory, and a processing unit. The memory is adapted to store program code for receiving user input of the mobile platform, while the processing unit is adapted to access and execute instructions included in the program code. When the instructions are executed by the processing unit, the processing unit directs the mobile platform to capture a sequence of images with the camera, where the sequence of images includes images of a user-guided object in proximity to a planar surface that is separate and external to the mobile platform. The processing unit further directs the mobile platform to track movement of the user-guided object about the planar surface by analyzing the sequence of images and also recognize the user input to the mobile platform based on the tracked movement of the user-guided object.

The above and other aspects, objects, and features of the present disclosure will become apparent from the following description of various embodiments, given in conjunction with the accompanying drawings.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIGS. 1A and 1B illustrate a front side and a backside, respectively, of a mobile platform that is configured to receive user input via a front-facing camera.

FIGS. 2A and 2B illustrate top and side views, respectively, of a mobile platform receiving alphanumeric user input via a front-facing camera.

FIG. 3A is a diagram illustrating a mobile device receiving user input while the mobile device in a portrait orientation with a front-facing camera in a top position.

FIG. 3B is a diagram illustrating a mobile device receiving user input while the mobile device in a portrait orientation with a front-facing camera in a bottom position.

FIG. 4A is a diagram illustrating three separate drawing regions for use by a user when drawing virtual characters.

FIG. 4B illustrates various strokes drawn by a user in their corresponding regions.

FIG. 5 illustrates a top view of a mobile platform receiving mouse/touch input from a user.

FIG. 6 is a diagram illustrating a mobile platform displaying a predicted alphanumeric character on a front-facing screen prior to the user completing the strokes of the alphanumeric character.

FIG. 7A is a flowchart illustrating a process of receiving user input by a mobile platform.

FIG. 7B is a flowchart illustrating a process of optical fingertip tracking by a mobile platform.

FIG. 8 is a diagram illustrating a mobile platform identifying a fingertip bounding box by receiving user input via a touch screen display.

FIG. 9 is a flowchart illustrating a process of learning fingertip tracking.

FIG. 10 is a functional block diagram illustrating a mobile platform capable of receiving user input via a front-facing camera.

### DETAILED DESCRIPTION

Reference throughout this specification to “one embodiment”, “an embodiment”, “one example”, or “an example” means that a particular feature, structure, or characteristic described in connection with the embodiment or example is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Any example or embodiment described herein is not to be construed as preferred or advantageous over other examples or embodiments.

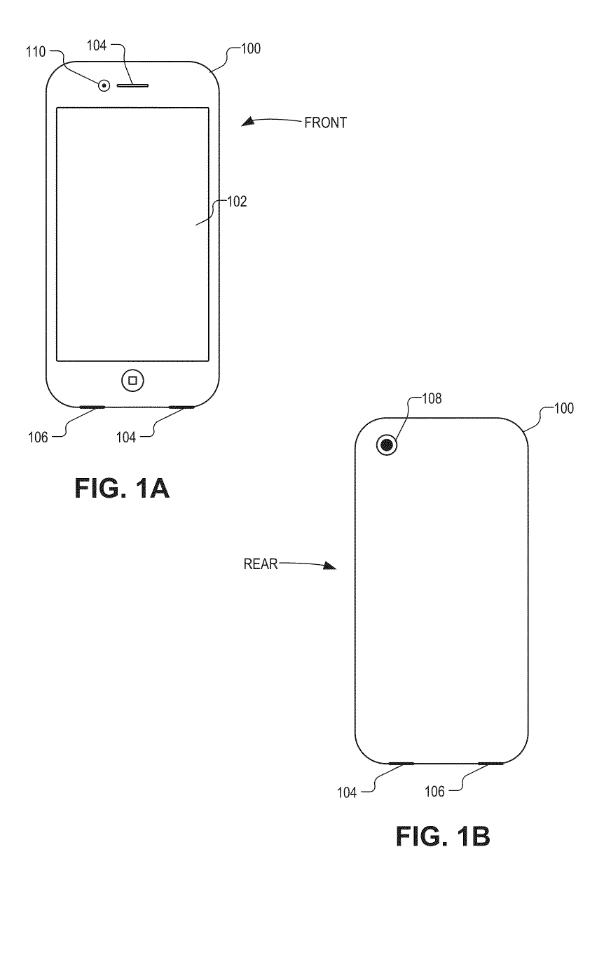

FIGS. 1A and 1B illustrate a front side and a backside, respectively, of a mobile platform 100 that is configured to receive user input via a front-facing camera 110. Mobile platform 100 is illustrated as including a front-facing display 102, speakers 104, and microphone 106. Mobile platform 100 further includes a rear-facing camera 108 and front-facing camera 110 for capturing images of an environment. Mobile platform 100 may further include a sensor system that includes sensors such as a proximity sensor, an accelerometer, a gyroscope or the like, which may be used to assist in determining the position and/or relative motion of mobile platform 100.

As used herein, a mobile platform refers to any portable electronic device such as a cellular or other wireless communication device, personal communication system (PCS) device, personal navigation device (PND), Personal Information Manager (PIM), Personal Digital Assistant (PDA), or other suitable mobile device. Mobile platform 100 may be capable of receiving wireless communication and/or navigation signals, such as navigation positioning signals. The term “mobile platform” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile platform” is intended to include all electronic devices, including wireless communication devices, computers, laptops, tablet computers, etc. which are capable of optically tracking a user-guided object via a front-facing camera for recognizing user input.

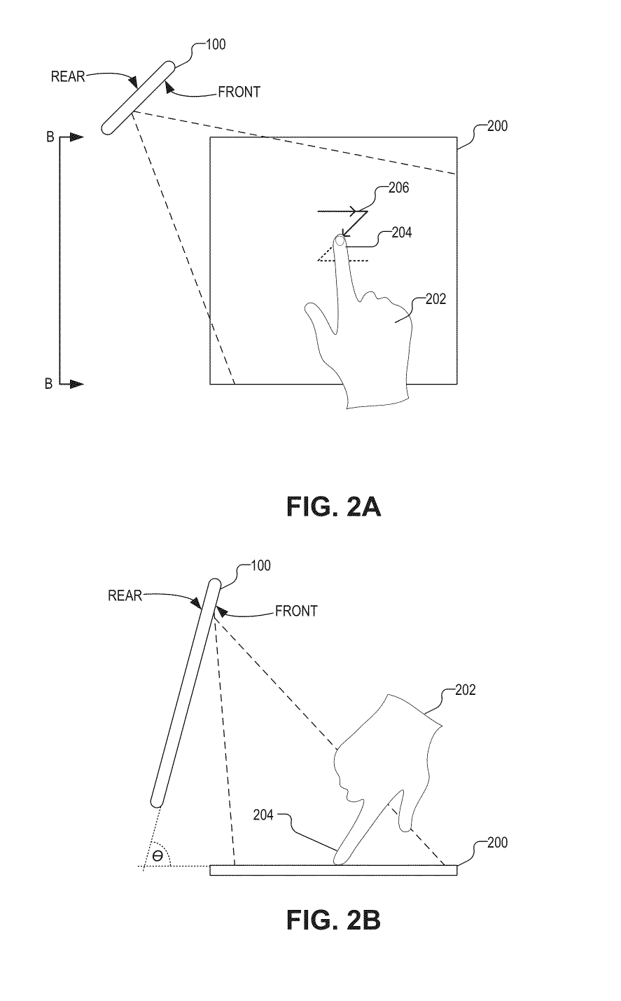

FIGS. 2A and 2B illustrate top and side views, respectively, of mobile platform 100 receiving alphanumeric user input via front-facing camera 110 (e.g., see front-facing camera 110 of FIG. 1). Mobile platform 100 captures a sequence of images with its front-facing camera 110 of a user-guided object. In this embodiment, the user-guided object is a fingertip 204 belonging to user 202. However, in other embodiments the user-guided object may include other writing implements such as a user's entire finger, a stylus, a pen, a pencil, or a brush, etc.

The mobile platform 100 captures the series of images and in response thereto tracks the user-guided object (e.g., fingertip 204) as user 202 moves fingertip 204 about surface 200. In one embodiment, surface 200 is a planar surface and is separate and external to mobile platform 100. For example, surface 200 may be a table top or desk top. As shown in FIG. 2B, in one aspect, the user-guided object is in contact with surface 200 as the user 202 moves the object across surface 200.

The tracking of the user-guided object by mobile platform 100 may be analyzed by mobile platform 100 in order to recognize various types of user input. For example, the tracking may indicate user input such as alphanumeric characters (e.g., letters, numbers, and symbols), gestures, and/or mouse/touch control input. In the example of FIG. 2A, user 202 is shown completing one or more strokes of an alphanumeric character 206 (e.g., letter “Z”) by guiding fingertip 204 across surface 200. By capturing a series of images as user 202 draws the virtual letter “Z”, mobile platform 100 can track fingertip 204 and then analyze the tracking to recognize the character input.

As shown in FIGS. 2A and 2B, the front of mobile platform 100 is facing the user 202 such that the front-facing camera can capture images of the user-guided object (e.g., fingertip 204). Furthermore, embodiments of the present disclosure may include mobile platform 100 positioned at an angle θ with respect to surface 200, such that both the front-facing camera can capture images of fingertip 204 and such that user 202 can view the front-facing display (e.g., display 102) of mobile platform 100 at the same time. In one embodiment, regardless of whether mobile platform 100 is in a portrait or landscape orientation, angle θ may be in the range of about 45 degrees to about 135 degrees.

As shown in FIG. 2A, mobile platform 100 and user 202 are situated such that the camera of mobile platform 100 captures images of a back (i.e., dorsal) side of fingertip 204. That is, user 202 may position their fingertip 204 such that the front-side (i.e., palmar) of fingertip 204 is facing surface 200 and that the back-side (i.e., dorsal) of fingertip 204 is generally facing towards mobile platform 100. Thus, when the user-guided object is a fingertip, embodiments of the present disclosure may include the tracking of the back (i.e., dorsal) side of a user's fingertip. As will be discussed in more detail below, when a user positions the front (palmar) side of their fingertip towards the planar surface 200, part or all of fingertip 204 may become occluded, either by the remainder of the finger or by other fingers of the same hand. Thus, embodiments for tracking fingertip 204 may include tracking a partially, or completely occluded fingertip. In one example, tracking an occluded fingertip may include inferring its location in a current frame based on the location of the fingertip in previous frames.

Furthermore, FIG. 2B illustrates fingertip 204 in direct contact with surface 200. Direct contact between fingertip 204 and surface 200 may also result in the deformation of fingertip 204. That is, as user 202 presses fingertip 204 against surface 200 the shape and/or size of fingertip 204 may change. Thus, embodiments of tracking fingertip 204 by mobile platform 100 must be robust enough to account for these deformations.

Direct contact between fingertip 204 and surface 200 may also provide user 202 with haptic feedback when user 202 is providing user input. For example, surface 200 may provide haptic feedback as to the location of the current plane on which the user 202 is guiding fingertip 204. That is, when user 202 lifts fingertip 204 off of surface 200 upon completion of a character or a stroke, the user 202 may then begin another stroke or another character once they feel the surface 200 with their fingertip 204. Using the surface 200 to provide haptic feedback allows user 202 to maintain a constant plane for providing user input and may not only increase accuracy of user 202 as they guide their fingertip 204 about surface 200, but may also improve the accuracy of tracking and recognition by mobile platform 100.

Although FIG. 2B illustrates fingertip 204 in direct contact with surface 200, other embodiments may include user 202 guiding fingertip 204 over surface 200 without directly contacting surface 200. In this example, surface 200 may still provide haptic feedback to user 202 by serving as a visual reference for maintaining movement substantially along a plane. In yet another example, surface 200 may provide haptic feedback to user 202 where user 202 allows other, non-tracked, fingers to touch surface 200, while the tracked fingertip 204 is guided above surface 200 without touching surface 200 itself.

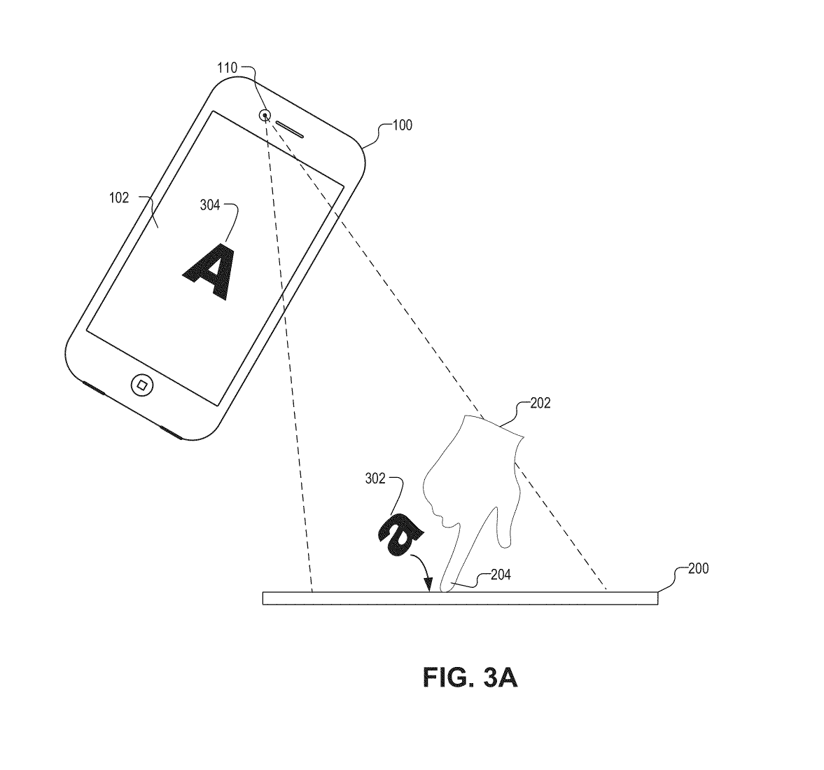

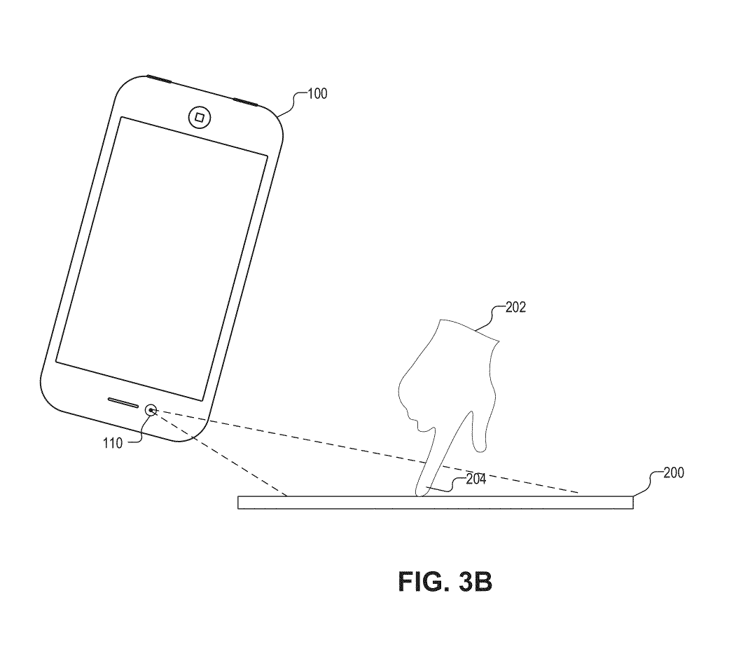

FIG. 3A is a diagram illustrating mobile device 100 receiving user input while the mobile device in a portrait orientation with front-facing camera 110 in a top position. In one embodiment, the front-facing camera 110 being in the top position refers to when the front-facing camera 110 is located off center of the front side of mobile platform 100 and where the portion of the front side that camera 110 is located on is the furthest from surface 200.

In the illustrated example of FIG. 3A, user 202 guides fingertip 204 across surface 200 to draw a letter “a”. In response, mobile platform 100 may show the recognized character 304 on the front-facing display 102 so as to provide immediate feedback to user 202.

FIG. 3B is a diagram illustrating mobile device receiving user input while the mobile device in a portrait orientation with front-facing camera 110 in a bottom position. In one embodiment, the front-facing camera 110 being in the bottom position refers to when the front-facing camera 110 is located off center of the front side of mobile platform 100 and where the portion of the front side that camera 110 is located on is the closest to surface 200. In some embodiments, orienting the mobile platform 200 with front-facing camera 110 in the bottom position may provide front-facing camera 110 with an improved view for tracking fingertip 204 and thus may provide for improved character recognition.

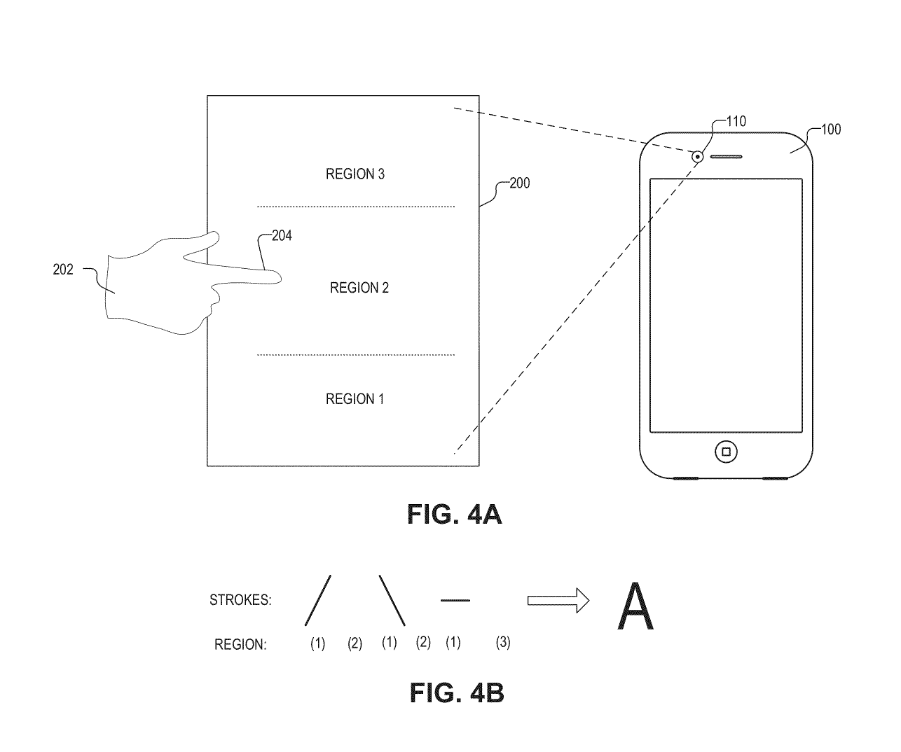

FIG. 4A is a diagram illustrating three separate drawing regions for use by user 202 when drawing virtual characters on surface 200. The three regions illustrated in FIG. 4A are for use by user 202 so that mobile platform 100 can differentiate each separate character drawn by user 202. User 202 may begin writing the first stroke of a character in region 1. When user 202 completes the first stroke of the current letter and wants to begin the next stroke of the current letter user 202 may move fingertip 204 into region 2 to start the next stroke. User 202 repeats this process of moving between region 1 and region 2 for each stroke of the current character. User 202 may then move fingertip 204 to region 3 to indicate that the current character is complete. Accordingly, fingertip 204 in region 1 indicates to mobile platform 100 that user 202 is writing the current letter; fingertip 204 in region 2 indicates that user 202 is still writing the current letter but starting the next stroke of the current letter; and fingertip 204 in region 3 indicates that the current letter is complete and/or that a next letter is starting.

FIG. 4B illustrates various strokes drawn by user 202 in their corresponding regions to input an example letter “A”. To begin, user 202 may draw the first stroke of the letter “A” in region 1. Next, user 202 moves fingertip 204 to region 2 to indicate the start of the next stroke of the current letter. The next stroke of the letter “A” is then drawn in region 1. Once the second stroke of the letter “A” is completed in region 1, user 202 may again return fingertip 204 to region 2. The last stroke of the letter “A” is then drawn by user 202 in region 1. Then to indicate completion of the current letter and/or to begin the next letter, user 202 moves fingertip 204 to region 3. The tracking of these strokes and movement between regions results in mobile platform recognizing the letter “A”.

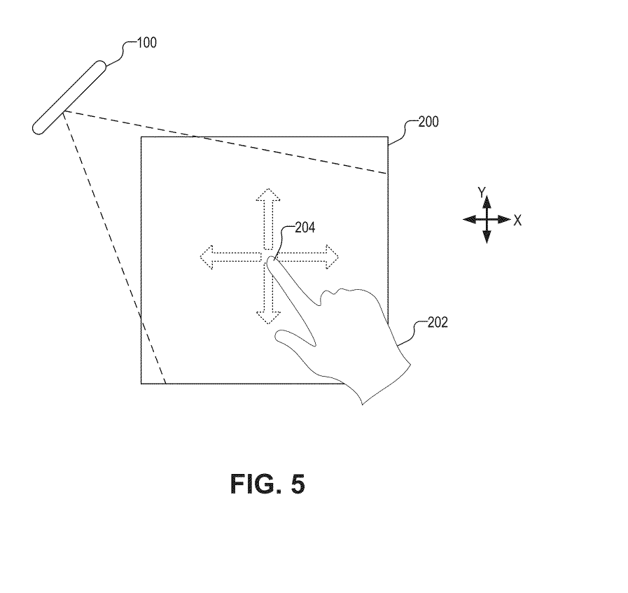

FIG. 5 illustrates a top view of mobile platform 100 receiving mouse/touch input from user 202. As mentioned above, user input recognized by mobile platform 100 may include gestures and/or mouse/touch control. For example, as shown in FIG. 5, user 202 may move fingertip 204 about surface 200 where mobile platform 100 tracks this movement of fingertip 204 along an x-y coordinate plane. In one embodiment, movement of fingertip 204 by user 202 corresponds to a gesture such as swipe left, swipe right, swipe up, swipe down, next page, previous page, scroll (up, down, left, right), etc. Thus, embodiments of the present disclosure allow the user 202 to use a surface 200 such as a table or desk for mouse or touch screen input. In one embodiment, tracking of fingertip 204 on surface 200 allows the arm of user 202 to remain rested on surface 200 without requiring user 202 to keep their arm in the air. Furthermore, user 202 does not have to move their hand to the mobile platform 100 in order to perform gestures such as swiping. This may provide for faster input and also prevents the visible obstruction of the front-facing display as is typical with prior touch screen input.

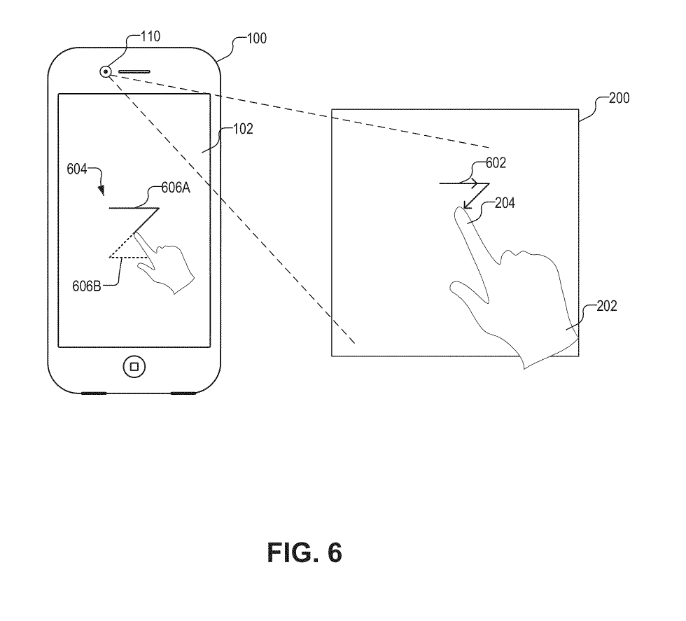

FIG. 6 is a diagram illustrating mobile platform 100 displaying a predicted alphanumeric character 604 on front-facing display 102 prior to the user completing the strokes 602 of an alphanumeric character on surface 200. Thus, embodiments of the present disclosure may include mobile platform 100 predicting user input prior to the user completing the user input. For example, FIG. 6 illustrates user 202 beginning to draw the letter “Z” by guiding fingertip 204 along surface 200 by making the beginning strokes 602 of the letter. While user 202 is drawing the letter and before user 202 has completed drawing the letter, mobile device 100 monitors the stroke(s), predicts that user 202 is drawing the letter “Z” and then displays the predicted character 604 on front-facing display 102 to provide feedback to user 202. In one embodiment, mobile device 100 provides a live video stream of the images captured by front-facing camera 110 on display 102 as user 202 performs the strokes 602. Mobile device 100 further provides predicted character 604 as an overlay (with transparent background) over the video stream. As shown the predicted character 604 may include a completed portion 606A (shown in FIG. 6 as a solid line) and a to-be-completed portion 606B (shown in FIG. 6 as a dashed line). The completed portion 606A may correspond to tracked movement of fingertip 204 which represents the portion of the alphanumeric character drawn by user 202 thus far, while the to-be-completed portion 606B corresponds to a remaining portion of the alphanumeric character which represents the portion of the alphanumeric character yet to be drawn by user 202. Although FIG. 6 illustrates the completed portion 606A as a solid line and to-be-completed portion 606B as a dashed line, other embodiments may differentiate between completed and to-be-completed portions by using differing colors, differing line widths, animations, or a combination of any of the above. Furthermore, although FIG. 6 illustrates mobile device 100 predicting the alphanumeric character being drawn by user 202, mobile device 100 may instead, or in addition, be configured to predict gestures drawn by user 202, as well.

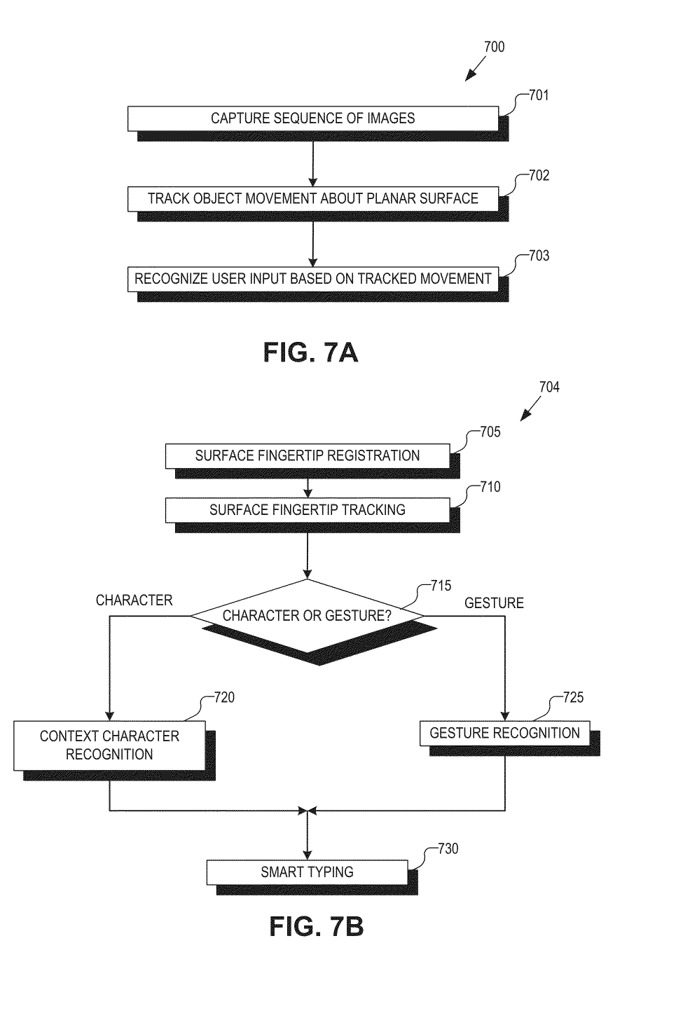

FIG. 7A is a flowchart illustrating a process 700 of receiving user input by a mobile platform (e.g. mobile platform 100). In process block 701, a camera (e.g., front-facing camera 110 or rear-facing camera 108) captures a sequence of images. As discussed above, the images include images of a user-guided object (e.g., finger, fingertip, stylus, pen, pencil, brush, etc.) that is in proximity to a planar surface (e.g., table-top, desktop, etc.). In one example, the user-guided object is in direct contact with the planar surface. However, in other examples, the user may hold or direct the object to remain close or near the planar surface while the object is moved. In this manner, the user may allow the object to “hover” above the planar surface but still use the surface as a reference for maintaining movement substantially along the plane of the surface. Next, in process block 702, movement of the user-guided object is tracked about the planar surface. Then in process block 703, user input is recognized based on the tracked movement of the user-guided object. In one aspect, the user input includes one or more strokes of an alphanumeric character, a gesture, and/or mouse/touch control for the mobile platform.

FIG. 7B is a flowchart illustrating a process 704 of optical fingertip tracking by a mobile platform (e.g. mobile platform 100). Process 704 is one possible implementation of process 700 of FIG. 7A. Process 704 begins with process block 705 and surface fingertip registration. Surface fingertip registration 705 includes registering (i.e., identifying) at least a portion of the user-guided object that is to be tracked by the mobile platform. For example, just a fingertip of a user's entire finger may be registered so that the system only tracks the user's fingertip. Similarly, the tip of a stylus may be registered so that the system only tracks the tip of the stylus as it moves about a table top or desk.

Process block 705 includes at least two ways to achieve fingertip registration: (1) applying a machine-learning-based object detector to the sequence of images captured by the front-facing camera; or (2) receiving user input via a touch screen identifying the portion of the user-guided object that is to be tracked. In one embodiment, a machine-learning-based object detector includes a decision forest based fingertip detector that uses a decision forest algorithm to first train the image data of fingertip from many sample images (e.g., fingertips on various surfaces, various lighting, various shape, different resolution, etc.) and then use this data to identify the fingertip in subsequent frames (i.e., during tracking). This data could also be stored for future invocations of the virtual keyboard so the fingertip detector can automatically detect the user's finger based on the previously learned data. As mentioned above, the fingertip and mobile platform may be positioned such that the camera captures images of a back-side (i.e., dorsal) of the user's fingertip. Thus, the machine-learning based object detector may detect and gather data related to the back-side of user fingertips.

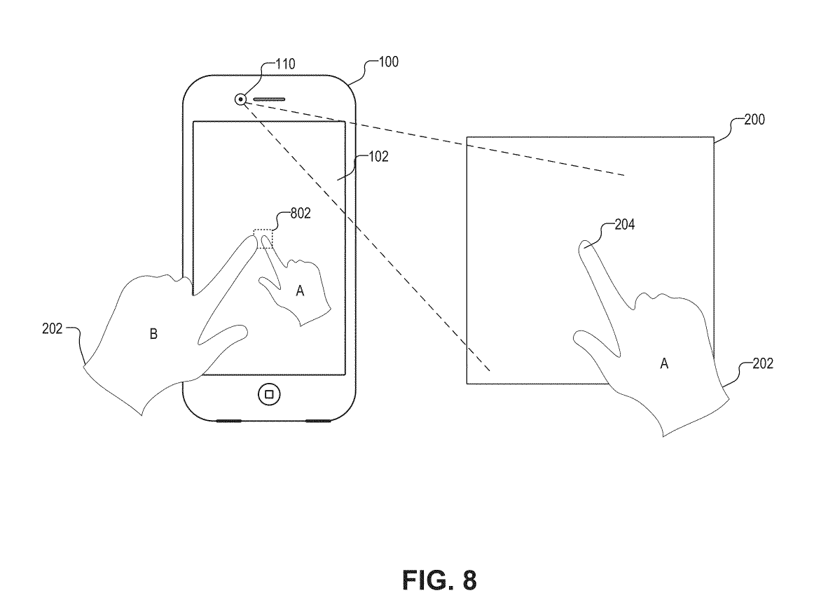

A second way of registering a user's fingertip includes receiving user input via a touch screen on the mobile platform. For example, FIG. 8 is a diagram illustrating mobile platform 100 identifying a fingertip bounding box 802 for tracking by receiving user input via a touch screen display 102. That is, in one embodiment, mobile platform 100 provides a live video stream (e.g., sequence of images) captured by front-facing camera 110. In one example, user 202 leaves hand “A” on surface 200, while with the user's other second hand “B” selects, via touch screen display 102, the appropriate finger area to be tracked by mobile platform 100. The output of this procedure may be bounding box 802 that is used by the system for subsequent fingertip 204 tracking.

Returning now to process 704 of FIG. 7B, once the fingertip is registered in process block 705, process 704 proceeds to process block 710 where the fingertip is tracked by mobile platform 100. As will be discussed in more detail below, mobile platform 100 may track the fingertip using one or more sub-component trackers, such as a bidirectional optical flow tracker, an enhanced decision forest tracker, and a color tracker. During operation, part or all of a user's fingertip may become occluded, either by the remainder of the finger or by other fingers of the same hand. Thus, embodiments for tracking a fingertip may include tracking a partially, or completely occluded fingertip. In one example, tracking an occluded fingertip may include inferring its location in a current frame (e.g., image) based on the location of the fingertip in previous frames. Process blocks 705 and 710 are possible implementations of process block 702 of FIG. 7A. Tracking data collected in process block 710 is then passed to decision block 715 where the tracking data representative of movement of the user's fingertip is analyzed to determine whether the movement is representative of a character or a gesture. Process blocks 720 and 725 include recognizing the appropriate contextual character and/or gesture, respectively. In one embodiment, context character recognition 720 includes applying any known optical character recognition technique to the tracking data in order to recognize an alphanumeric character. For example, handwriting movement analysis can be used which includes capturing motions, such as the order in which the character strokes are drawn, the direction, and the pattern of putting the fingertip down and lifting it. This additional information can make the resulting recognized character more accurate. Decision block 715 and process blocks 720 and 725, together, may be one possible implementation of process block 703 of FIG. 7A.

Once the character and/or gesture is registered process 700 proceeds to process block 730 where various smart typing procedures may be implemented. For example, process block 730 may include applying an auto complete feature to the receiving user input. Auto complete works so that when the writer inputs a first letter or letters of a word, mobile platform 100 predicts one or more possible words as choices. The predicted word may then be presented to the user via the mobile platform display. If the predicted word is in fact the user's intended word, the user can then select it (e.g., via touch screen display). If the predicted word that the user wants is not predicted correctly by mobile platform 100, the user may then enter the next letter of the word. At this time, the predicted word choice(s) may be altered so that the predicted word(s) provided on the mobile platform display begin with the same letters as those that have been entered by the user.

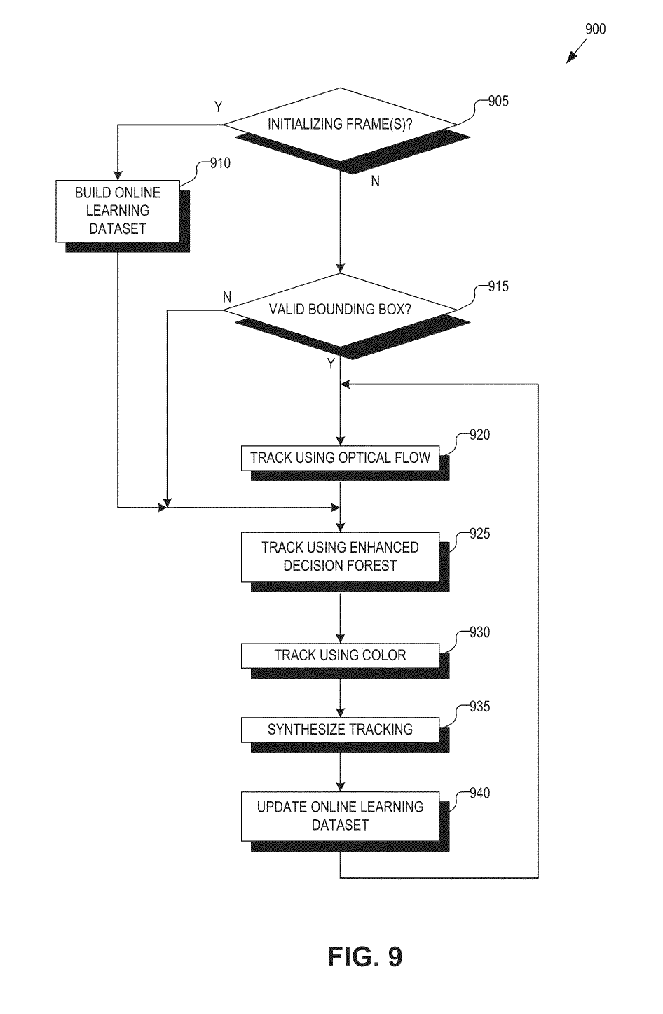

FIG. 9 is a flowchart illustrating a process 900 of learning fingertip tracking. Process 900 begins at decision block 905 where it is determined whether the image frames acquired by the front-facing camera are in an initialization process. If so, then, using one or more of these initially captured images, process block 910 builds an online learning dataset. In one embodiment, the online learning dataset includes the templates of positive samples (true fingertips), and the templates of negative samples (false fingertips or background). The online learning dataset is the learned information that's retained and used to ensure good tracking. Different tracking algorithms will have different characteristics that describe the features that they track so different algorithms could have different datasets.

Next, since process block 910 just built the online learning dataset, process 900 skips decision block 915 and tracking using optical flow analysis in block 920 since no valid previous bounding box is present. If however, in decision block 905 it is determined that the acquired image frames are not in the initialization process, then decision block 915 determines whether there is indeed a valid previous bounding box for tracking and, if so, utilizes a bidirectional optical flow tracker in block 920 to track the fingertip. Various methods of optical flow computation may be implemented by the mobile platform in process block 920. For example, the mobile platform may compute the optical flow using phase correlation, block-based methods, differential methods, discrete optimization methods, and the like.

In process block 925, the fingertip is also tracked using an Enhanced Decision Forest (EDF) tracker. In one embodiment, the EDF tracker utilizes the learning dataset in order to detect and track fingertips in new image frames. Also, shown in FIG. 9, is process block 930, which includes fingertip tracking using color. Color tracking is the ability to take one or more images, isolate a particular color and extract information about the location of a region of that image that contains just that color (e.g., fingertip). Next, in process block 935, the results of the three sub-component trackers (i.e., optical flow tracker, EDF tracker, and color tracker) are synthesized in order to provide tracking data (including the current location of the fingertip). In one example, synthesizing the results of the sub-component trackers may include weighting the results and then combining them together. The online learning dataset may then be updated using this tracking data in process block 940. Process 900 then returns to process block 920 to continue tracking the user's fingertip using all three sub-component trackers.

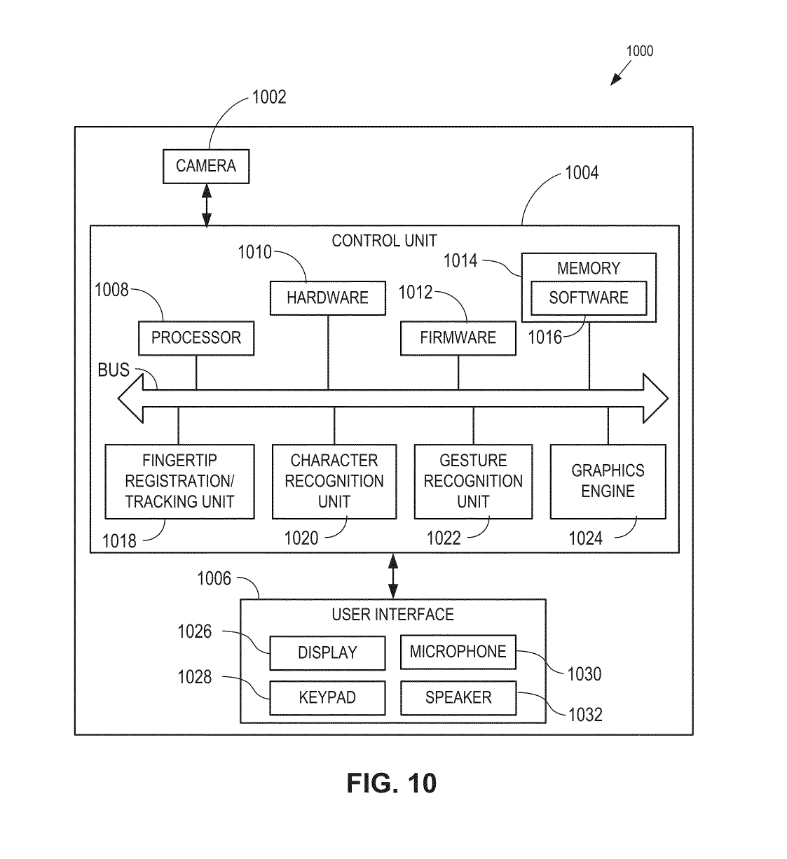

FIG. 10 is a functional block diagram illustrating a mobile platform 1000 capable of receiving user input via front-facing camera 1002. Mobile platform 1000 is one possible implementation of mobile platform 100 of FIGS. 1A and 1B. Mobile platform 1000 includes front-facing camera 1002 as well as a user interface 1006 that includes the display 1026 capable of displaying preview images captured by the camera 1002 as well as alphanumeric characters, as described above. User interface 1006 may also include a keypad 1028 through which the user can input information into the mobile platform 1000. If desired, the keypad 1028 may be obviated by utilizing the front-facing camera 1002 as described above. In addition, in order to provide the user with multiple ways to provide user input, mobile platform 1000 may include a virtual keypad presented on the display 1026 where the mobile platform 1000 receives user input via a touch sensor. User interface 1006 may also include a microphone 1030 and speaker 1032, e.g., if the mobile platform is a cellular telephone.

Mobile platform 1000 includes a fingertip registration/tracking unit 1018 that is configured to perform object-guided tracking. In one example, fingertip registration/tracking unit 1018 is configured to perform process 900 discussed above. Of course, mobile platform 1000 may include other elements unrelated to the present disclosure, such as a wireless transceiver.

Mobile platform 1000 also includes a control unit 1004 that is connected to and communicates with the camera 1002 and user interface 1006, along with other features, such as the sensor system fingertip registration/tracking unit 1018, the character recognition unit 1020 and the gesture recognition unit 1022. The character recognition unit 1020 and the gesture recognition unit 1022 accepts and processes data received from the fingertip registration/tracking unit 1018 in order to recognize user input as characters and/or gestures. Control unit 1004 may be provided by a processor 1008 and associated memory 1014, hardware 1010, software 1016, and firmware 1012.

Control unit 1004 may further include a graphics engine 1024, which may be, e.g., a gaming engine, to render desired data in the display 1026, if desired. fingertip registration/tracking unit 1018, character recognition unit 1020, and gesture recognition unit 1022 are illustrated separately and separate from processor 1008 for clarity, but may be a single unit and/or implemented in the processor 1008 based on instructions in the software 1016 which is run in the processor 1008. Processor 1008, as well as one or more of the fingertip registration/tracking unit 1018, character recognition unit 1020, gesture recognition unit 1022, and graphics engine 1024 can, but need not necessarily include, one or more microprocessors, embedded processors, controllers, application specific integrated circuits (ASICs), advanced digital signal processors (ADSPs), and the like. The term processor describes the functions implemented by the system rather than specific hardware. Moreover, as used herein the term “memory” refers to any type of computer storage medium, including long term, short term, or other memory associated with mobile platform 1000, and is not to be limited to any particular type of memory or number of memories, or type of media upon which memory is stored.

The processes described herein may be implemented by various means depending upon the application. For example, these processes may be implemented in hardware 1010, firmware 1012, software 1016, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the processes may be implemented with modules (e.g., procedures, functions, and so on) that perform the functions described herein. Any computer-readable medium tangibly embodying instructions may be used in implementing the processes described herein. For example, program code may be stored in memory 1014 and executed by the processor 1008. Memory 1014 may be implemented within or external to the processor 1008.

If implemented in firmware and/or software, the functions may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, Flash Memory, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The order in which some or all of the process blocks appear in each process discussed above should not be deemed limiting. Rather, one of ordinary skill in the art having the benefit of the present disclosure will understand that some of the process blocks may be executed in a variety of orders not illustrated.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Various modifications to the embodiments disclosed herein will be readily apparent to those skilled in the art, and the generic principles defined herein may be applied to other embodiments without departing from the spirit or scope of the invention. For example, although FIGS. 2-6 and 8 illustrate the use of a front-facing camera of the mobile platform, embodiments of the present invention are equally applicable for use with a rear-facing camera, such as camera 108 of FIG. 1B. Thus, the present invention is not intended to be limited to the embodiments shown herein but is to be accorded the widest scope consistent with the principles and novel features disclosed herein.

What is claimed is:

1. A method of receiving user input by a mobile platform, the method comprising:
capturing a sequence of images with a camera of the mobile platform, wherein the sequence of images includes images of a user-guided object in proximity to a planar surface that is separate and external to the mobile platform;
tracking movement of the user-guided object about the planar surface by analyzing the sequence of images; and
recognizing the user input to the mobile platform based on the tracked movement of the user-guided object.

2. The method of claim 1, wherein the user input is at least one of an alphanumeric character, a gesture, or a mouse/touch control.

3. The method of claim 1, wherein the user-guided object is at least one of a finger of the user, a fingertip of the user, a stylus, a pen, a pencil, or a brush.

4. The method of claim 1, wherein the user input is an alphanumeric character, the method further comprising displaying the alphanumeric character on a front-facing screen of the mobile platform.

5. The method of claim 4, further comprising:
monitoring one or more strokes of the alphanumeric character;
predicting the alphanumeric character prior to completion of all of the one or more strokes of the alphanumeric character; and
displaying at least some of the predicted alphanumeric character on the front-facing screen prior to the completion of all of the one or more strokes of the alphanumeric character.

6. The method of claim 5, wherein displaying at least some of the predicted alphanumeric character includes displaying a first portion of the alphanumeric character corresponding to movement of the user-guided object thus far, and also indicating on the screen a second portion of the alphanumeric character corresponding to a remainder of the alphanumeric character.

7. The method of claim 1, wherein tracking movement of the user-guided object includes first registering at least a portion of the user-guided object, wherein registering at least a portion of the user-guided object includes applying a decision forest-based object detector to at least one of the sequence of images.

8. The method of claim 1, wherein tracking movement of the user-guided object includes first registering at least a portion of the user-guided object, wherein registering at least a portion of the user-guided object includes:
displaying on a front-facing touch screen of the mobile platform a preview image of the user-guided object; and
receiving touch input via the touch screen identifying a portion of the user-guided object that is to be tracked.

9. The method of claim 1, further comprising:
building a learning dataset of a portion of the user-guided object based on at least one of the sequence of images; and
updating the learning dataset with tracking results as the user-guided object is tracked to improve subsequent tracking performance.

10. The method of claim 1, wherein the camera is a front-facing camera of the mobile platform.

11. A non-transitory computer-readable medium including program code stored thereon which when executed by a processing unit of a mobile platform directs the mobile platform to receive user input, the program code comprising instructions to:
capture a sequence of images with a camera of the mobile platform, wherein the sequence of images includes images of a user-guided object in proximity to a planar surface that is separate and external to the mobile platform;
track movement of the user-guided object about the planar surface by analyzing the sequence of images; and
recognize the user input to the mobile platform based on the tracked movement of the user-guided object.

12. The medium of claim 11, wherein the user input is an alphanumeric character, the program code further comprising instructions to:
monitor one or more strokes of the alphanumeric character;
predict the alphanumeric character prior to completion of all of the one or more strokes of the alphanumeric character; and
display at least some of the predicted alphanumeric character on the front-facing screen prior to completion of all of the one or more strokes of the alphanumeric character.

13. The medium of claim 11, wherein the instructions to track movement of the user-guided object includes instructions to first register at least a portion of the user-guided object, wherein the instructions to register at least a portion of the user-guided object includes instructions to apply a decision forest-based object detector to at least one of the sequence of images.

14. The medium of claim 11, wherein the instructions to track movement of the user-guided object includes instructions to first register at least a portion of the user-guided object, wherein the instructions to register at least a portion of the user-guided object includes instructions to:
display on a front-facing touch screen of the mobile platform a preview image of the user-guided object; and
receive touch input via the touch screen identifying the portion of the user-guided object that is to be tracked.

15. The medium of claim 11, wherein the program code further comprises instructions to:
build an learning dataset of a portion of the user-guided object based on at least one of the sequence of images; and
update the learning dataset with tracking results as the user-guided object is tracked to improve subsequent tracking performance.

16. A mobile platform, comprising:
means for capturing a sequence of images that include a user-guided object that is in proximity to a planar surface that is separate and external to the mobile platform;
means for tracking movement of the user-guided object about the planar surface; and
means for recognizing user input to the mobile platform based on the tracked movement of the user-guided object.

17. The mobile platform of claim 16, wherein the user input is an alphanumeric character, the mobile platform further comprising:
means for monitoring one or more strokes of the alphanumeric character;
means for predicting the alphanumeric character prior to completion of all of the one or more strokes of the alphanumeric character; and
means for displaying at least some of the predicted alphanumeric character on the front-facing screen prior to completion of all of the one or more strokes of the alphanumeric character.

18. The mobile platform of claim 17, wherein the means for displaying at least some of the predicted alphanumeric character includes means for displaying a first portion of the alphanumeric character corresponding to movement of the user-guided object thus far, and also means for indicating on the screen a second portion of the alphanumeric character corresponding to a remainder of the alphanumeric character.

19. The mobile platform of claim 16, wherein the means for tracking movement of the user-guided object includes means for first registering at least a portion of the user-guided object, wherein the means for registering at least a portion of the user-guided object includes means for applying a decision forest-based object detector to at least one of the sequence of images.

20. The mobile platform of claim 16, wherein the means for tracking movement of the user-guided object includes means for first registering at least a portion of the user-guided object, wherein the means for registering at least a portion of the user-guided object includes:
means for displaying on a front-facing touch screen of the mobile platform a preview image of the user-guided object; and
means for receiving touch input via the touch screen identifying the portion of the user-guided object that is to be tracked.

21. The mobile platform of claim 16, further comprising:
means for building an learning dataset of a portion of the user-guided object that is to be tracked based on at least one of the sequence of images; and
means for updating the learning dataset with tracking results as the user-guided object is tracked to improve subsequent tracking performance.

22. A mobile platform, comprising:
a camera;
memory adapted to store program code for receiving user input of the mobile platform; and
a processing unit adapted to access and execute instructions included in the program code, wherein when the instructions are executed by the processing unit, the processing unit directs the mobile platform to:
capture a sequence of images with the camera of the mobile platform, wherein the sequence of images includes images of a user-guided object in proximity to a planar surface that is separate and external to the mobile platform;
track movement of the user-guided object about the planar surface by analyzing the sequence of images; and
recognize the user input to the mobile platform based on the tracked movement of the user-guided object.

23. The mobile platform of claim 22, wherein the user input is at least one of an alphanumeric character, a gesture, or mouse/touch control.

24. The mobile platform of claim 22, wherein the user-guided object is at least one of a finger of the user, a fingertip of the user, a stylus, a pen, a pencil, or a brush.

25. The mobile platform of claim 22, wherein the user input is an alphanumeric character, the program code further comprising instructions to direct the mobile platform to display the alphanumeric character on a front-facing screen of the mobile platform.

26. The mobile platform of claim 25, wherein the program code further comprises instructions to direct the mobile platform to:
monitor one or more strokes of the alphanumeric character;
predict the alphanumeric character prior to completion of all of the one or more strokes of the alphanumeric character; and
display at least some of the predicted alphanumeric character on the front-facing screen prior to completion of all of the one or more strokes of the alphanumeric character.

27. The mobile platform of claim 26, wherein the instructions to display at least some of the predicted alphanumeric character includes instructions to display a first portion of the alphanumeric character corresponding to movement of the user-guided object thus far, and also indicate on the screen a second portion of the alphanumeric character corresponding to a remainder of the alphanumeric character.

28. The mobile platform of claim 22, wherein the instructions to track movement of the user-guided object includes instructions to first register at least a portion of the user-guided object, wherein the instructions to register at least a portion of the user-guided object includes instructions to apply a decision forest-based object detector to at least one of the sequence of images.

29. The mobile platform of claim 22, wherein the instructions to track movement of the user-guided object includes instructions to first register at least a portion of the user-guided object, wherein the instructions to register at least a portion of the user-guided object includes instructions to direct the mobile platform to:
display on a front-facing touch screen of the mobile platform a preview image of the user-guided object; and
receive touch input via the touch screen identifying the portion of the user-guided object that is to be tracked.

30. The mobile platform of claim 22, wherein the program code further comprises instructions to:
build an learning dataset of a portion of the user-guided object that is to be tracked based on at least one of the sequence of images; and
update the learning dataset with tracking results as the user-guided object is tracked to improve subsequent tracking performance.

31. The mobile platform of claim 22, wherein the camera is a front-facing camera of the mobile platform.
